(19) United States
(12) Patent Application Publication
(10) Pub. No.: US 2015/0332366 A1
(43) Pub. Date: Nov. 19, 2015

(54) Method for Automated Design and Assembly of Customized Apparel and Other Sewn Products

(71) Applicant: Sharon L. Ginocchi, Allison Park, PA (US)

(72) Inventor: Sharon L. Ginocchi, Allison Park, PA (US)

(21) Appl. No.: 14/698,142

(22) Filed: Apr. 28, 2015

Related U.S. Application Data
(60) Provisional application No. 61/993,590, filed on May 15, 2014.

(51) Int. Cl. G06Q 30/06

(52) U.S. Cl. CPC G06Q 30/0621

(57) ABSTRACT

A method of designing and assembling customized garments and other sewn items using a plurality of automated machines in communication with a computer, a viewing device, and a pattern database. A customer uploads measurements into a computer, and designs the desired garment or other sewn item by selecting patterns from a database, fabrics and notions. A virtual finished item is then displayed on a viewing device. The customer finalizes the design, and the garment or sewn item is then assembled according to instructions provided by the customer, the instructions sent directly from the computer to the plurality of automated machines. Human involvement in the assembly process is minimized, with the majority or all of the steps being performed automatically by the plurality of machines.

### CROSS REFERENCE TO RELATED APPLICATIONS

Reference is made to and priority claimed from U.S. provisional application Ser. No. 61/993,590 filed on 15 May 2014 by inventor Sharon L. Ginocchi, a.k.a. Sharon Powell Ginocchi.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE OF MATERIAL SUBMITTED ON A COMPACT DISC OR AS A TEXT FILE VIA THE EFS WEB SYSTEM

Not applicable.

### STATEMENT REGARDING PRIOR DISCLOSURES BY THE INVENTOR OR A JOINT INVENTOR

Not applicable.

### BACKGROUND OF THE INVENTION

### Field of the Invention

The present invention pertains to the field of apparel design and construction. More particularly, the present invention pertains to a method for automated design and assembly of apparel and other sewn products according to instructions from a customer, the entire process being fully automated with minimal human involvement.

### BACKGROUND ART

Historically, there are two ways a customer could obtain clothing: either by purchasing “prêt a porter” or “ready to wear” clothing, where the clothing is sewn according to the clothing company's own patterns for the mass market, or by purchasing “haute couture” or “customized” garments made exclusively for the customer. In either case, each garment is sewn by one or more humans operating one or more sewing machines, and/or by hand sewing. In the case of haute couture, a tailor typically makes a custom pattern for the customer, cuts the fabric according to the pattern, selects the fabric pieces to be sewn together, guides the pieces into the sewing machine, and otherwise constructs each garment and is involved in every step. Prêt a porter clothing is affordable because instead of a tailor, who is a person trained to make customized clothing, garment workers assemble the clothing by following a pattern customized to only fit one individual—the company's fit model. The garment workers typically lack the skill to make customized clothing. Haute couture, in contrast, is very expensive because highly customized clothing is produced by a skilled tailor made for a particular individual. Indeed, any sewn item, such as slipcovers for sofas, pillows, curtains, etc. are produced much in the same way as garments are created—either mass produced, or custom-designed and sewn.

As a result, those who cannot afford haute couture must spend a great deal of time trying on clothing and finding brands whose fit model's measurements are similar to their own. The trial and error of shopping is fun for some, but for many people, particularly those who are not average sized, the effort involved creates frustration. For home furnishings, the process is even more difficult, since pillows, sofas and other items are not standard sizes or shapes, and thus must be specially customized (or discarded and purchased anew).

Additionally, while it is common to take prêt a porter clothing to a tailor or seamstress to customize the clothing, alterations increase cost, and in most places, the alterations that are available are limited to simple hemming pant or skirt lengths. Complex alterations such as removing zippers, adding trim, or recutting and resetting sleeves are either too costly or unavailable. For such cases, it would be easier if the garment or other item was originally sewn properly the first time, since certain alterations are complicated due to the finished nature of the item, and proper alterations might require complete or partial disassembly and reassembly of the garment or item.

Often, a garment might fit, but the customer wants a different trim, or fabric, and either must accept what is available for purchase or walk away. How many of us have said “if it only came in another color!” when trying on clothing, or buying a sofa?

One problem that currently exists even for haute couture is that the finished garment is not easily visualized prior to assembly. Designers sketch their designs, which are then translated into real clothing, but a customer does not know exactly how something will look on them until the actual garment is made. Alterations in the design are usually performed during multiple fittings, although in some cases certain things cannot be changed, such a dress cut too short.

What is needed is a method to mass produce customized clothing and other sewn products with the price and convenience of mass produced garments and other sewn products. What is also needed is a way for customers to conveniently design their own customized clothing and other products, and be able to visualize the clothing or products as they would appear assembled before committing to any particular design, size, or fabric.

### BRIEF SUMMARY OF THE INVENTION

The invention is a method of automated design and assembly of customized garments and other sewn products. More particularly, the invention is a method of automating traditional garment and sewn product design and assembly by using a plurality of machines designed to select fabric, cut the selected fabric, and assemble the garment or other sewn product. Most or all steps are performed by the machines according to instructions received by the machines from a computer, the instructions themselves provided by a customer and inputted into the computer. Even more particularly, the invention is a method of providing the customer the ability to design a highly customized garment or other sewn product by choosing individual pattern pieces from a library database, and creating a virtual garment viewable on a screen before hard commitment to the selections and assembling a real garment or other sewn product. Further, the invention is a method of designing highly customized garments or other sewn products by allowing the customer to customize the fabric itself and not simply choose preprinted fabric.

### BRIEF DESCRIPTION OF THE DRAWINGS

The features and advantages of the invention will become apparent from a consideration of the subsequent detailed description presented in connection with accompanying drawings, in which:

FIG. 1 is a diagrammatic representation of a method of automated design and assembly of customized apparel and other sewn products according to the invention.

### DETAILED DESCRIPTION OF THE INVENTION

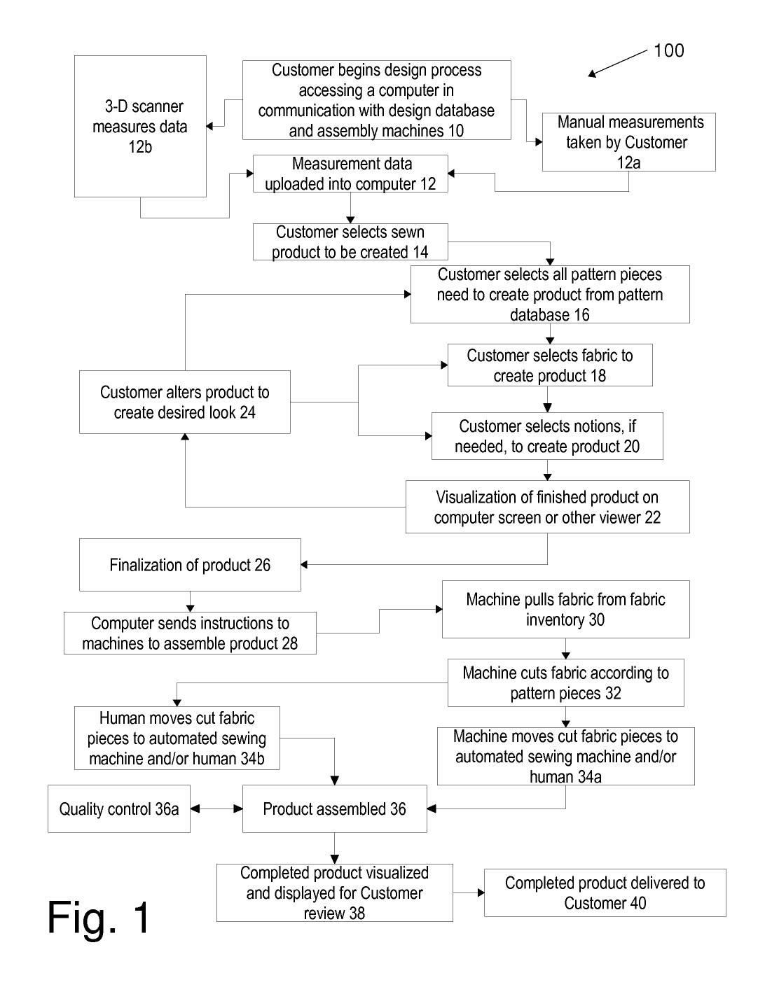

An embodiment of the method for automated design and assembly of customized apparel and other sewn products is shown in FIG. 1.

Looking now at FIG. 1, the method for automated design and assembly of customized apparel and other sewn products 100 commences by a customer accessing a computer in communication with a pattern database and a plurality of machines used to assemble a garment or other sewn product 10. It should be noted that “computer” here includes smartphones, and other devices in communication, wired or wirelessly, with the pattern database and the plurality of machines, and which either includes a screen for visualizing the selections, patterns, etc. and/or is in communication, wired or wirelessly, with a screen capable of visualizing the selections, etc. made by the customer. The desired measurement data is uploaded into the computer 12, either manually by the customer 12a, or alternatively, by a three-dimensional scanning machine in communication with the computer and which automatically uploads the data into the computer 12b. Next, the customer selects the type of product to be created 14. For instance, if the customer wants to design clothing, such as a dress, “dress” is selected from the choice menu. If the customer wants to design a pillow, then s/he would choose “pillow” and then the type of pillow, such as European sham, neck roll, etc. The customer then accesses a pattern database to choose the pattern pieces to make the desired product 16. For instance, if the customer selects a dress as the type of product to be created, from the database the customer would then select the type of neckline or collar, the style of the front and back of the dress, the sleeves, etc. choosing among different styles. In some embodiments, the customer can upload his or her own design, or alter the pattern pieces in the database. The customer then selects the fabric 18 to create the sewn product, and in an optional step 18a as shown in FIG. 1, the customer can create his or her own fabric surface design to be printed onto the selected fabric from step 18. After the fabric has been selected, notions, such as trim and buttons 20 are selected by the customer, and then a virtual finished product is displayed on the computer screen or other viewer 22. At this point, the customer can either adjust the design, by changing the pattern pieces, the fabric, and/or the notions 24 or if satisfied, can finalize the product design 26. The step of finalization 26 includes authorization of the design and the selections, and payment for the finished product.

Upon finalization, the design instructions are sent by the computer to a plurality of machines used to assemble the sewn product 28. A machine, typically a robotic arm, will locate and physically remove the fabric from the fabric inventory 30. A cutting machine, typically a laser, will cut the fabric according to the pattern pieces 32. In the next step, in one embodiment, a moving machine, typically a conveyor, will move the cut fabric pieces to an automated sewing machine or alternatively, to a human operating a conventional sewing machine 34a. In another embodiment, a human will collect the cut fabric pieces and move them to the automated sewing machine and/or to the human operating a conventional sewing machine 34b. In yet another embodiment (not shown), some fabric pieces are moved by the machine and other pieces are move by the human, and the product is assembled partially by the automated sewing machine and partially by the human operating the conventional sewing machine. Once the product is assembled (sewn) 36, the completed product is displayed for the customer's review 38. This step may include displaying the finished product physically on a hanger, shelf or using other appropriate means, or alternatively or in addition to, displaying the finished product on the computer screen or viewer. The completed product is then prepared for delivery to the customer, either by the customer physically accepting the product, or by mailing or other means of transporting the finished product to the customer 40.

During the assembling process 36, quality controls may be instituted in some embodiments 36a, where a human monitors the sewing process by the automated sewing machine, and in some cases, resews or sews other seams, before the product is finished and before the step of displaying the finished product 38. The Inventor understands that fully automated sewing may not be possible for some products, although it is an object of the invention to use automation and reduce the amount of human involvement as much as possible to reduce cost.

The Inventor is aware of experimental automated sewing machines and robotic transfer machines currently being developed by third parties. The SAM-1000, a fully automated sewing machine, and the Lowry, a lightweight Cartesian robot transfer device, both by SoftWear Automation, Inc. found at http://softwearautomation.com/portfolio-items/sam-1000/ and http://softwearautomation.com/portfolio-items/lowry/ are suitable machines for performing the Inventor's method of automated design and assembly of sewn products. Other machines needed to practice the method, such as conveyor belts made by mk Technology Group of 100-135 Highland Park Drive, Bloomfield Conn. http://www.mknorthamerica.com/Products/aluminum-conveyors/?gclid=CLCTvNb_MQCFZeDaQodx6MAqg to move fabric and notions from inventory to the machines, as well as other automated manipulation robots, such as the robotic picker made by IAM Robotics, LLC of 343 Eicher Road, Pittsburgh, Pa. www.iamrobotics.com/contact/ for retrieving notions and fabric, as well as moving cut fabric, or partially assembled products, are suitable for practicing the method according to the invention.

It is to be understood that the above-described arrangements are only illustrative of the application of the principles of the present invention. Numerous modifications and alternative arrangements may be devised by those skilled in the art without departing from the scope of the present invention.

What is claimed is:

1. A method for designing and assembling a sewn product comprising the steps of:
entering a set of measurements into a computer;
selecting a sewn product type to create from a pattern database;
selecting individual pattern pieces from the pattern database to form a completed design image;
choosing a desired fabric from a fabric database to be used to create the sewn product;
choosing desired notions from a notions database to be used to finish the sewn product,
wherein the pattern database, the fabric database, and the notions database are in communication with the computer;
finalizing the designed sewn product;
wherein the steps of entering, selecting, selecting, choosing, choosing, and finalizing are all performed by a customer;
retrieving the selected fabric and selected notions from a storage facility;
cutting the selected fabric using the selected pattern pieces;
moving the cut fabric pieces to an assembly area;
assembling the sewn product; and
delivering the finished sewn product,
wherein the step of retrieving the selected fabric and notions is performed automatically by a retrieval machine in communication with the computer after the sewn product is finalized;
wherein the step of cutting the selected fabric is performed automatically by a cutting machine in communication with the retrieval machine and the computer, after the selected fabric has been retrieved; and
wherein the step of assembling the sewn product further comprises at least one seam sewn automatically by a sewing machine in communication with the cutting machine and the computer, after the selected fabric is cut.

2. The method of claim 1, further comprising the step of finalizing the set of measurements by the customer before the step of finalizing the sewn product, wherein the step of finalizing the set of measurements comprises the customer performing at least one of reviewing, editing, and accepting the set of measurements.

3. The method of claim 1, further comprising the step of scanning by a three dimensional scanning device to obtain measurements before the step of entering the set of measurements into a computer.

4. The method of claim 3, wherein the step of scanning by the three dimensional scanning device further includes the three dimensional scanning device in communication with the computer, and the measurements obtained automatically uploading to the computer from the scanning device.

5. The method of claim 4, further comprising the step of finalizing the set of measurements by the customer before the step of finalizing the sewn product, wherein the step of finalizing the set of measurements comprises the customer performing at least one of reviewing, editing, and accepting the set of measurements.

6. The method of claim 1, wherein the retrieval machine, the cutting machine, and the sewing machine are all housed in a same facility.

7. The method of claim 1, wherein the retrieval machine, the cutting machine, and the sewing machine receive instructions only from the computer.

8. The method of claim 1, wherein the step of assembling the sewn product further comprises at least one or more seams sewn by a human using a second sewing machine.

9. The method of claim 1, after the step of finalizing the sewn product and before the step of retrieving the selected fabric and notions, further comprising the step of displaying the finalized sewn product on a viewing device as it would appear if assembled using the customer's selected product type, pattern pieces, fabric and notions, and pattern pieces.

10. The method of claim 1, further comprising the step of examining the assembled sewn product by a human after the step of assembling the sewn product and prior to the step of delivering the assembled sewn product.

11. The method of claim 1, wherein the computer communicates wirelessly with at least one of the retrieval machine, the cutting machine, and the sewing machine.

12. The method of claim 1, wherein the retrieval machine is a robotic arm.

13. The method of claim 1, wherein the cutting machine is a laser.

14. The method of claim 1, wherein the step of moving the cut fabric pieces to the assembly area is performed by at least one of human assistance and an automatic conveyor belt.

15. The method of claim 1, wherein the steps of retrieving, cutting, and assembling are all performed without human assistance.
